(19) United States
(12) Patent Application Publication
(10) Pub. No.: US 2010/0156225 A1
(43) Pub. Date: Jun. 24, 2010

(54) PERMANENT MAGNET MOTOR

(76) Inventor: Wayne M. Monson, Winnipeg (CA)

Correspondence Address: ADE & COMPANY INC., 2157 Henderson Highway, WINNIPEG, MB, R2G1P9, CA

(21) Appl. No.: 12/641,857

(22) Filed: Dec. 18, 2009

Related U.S. Application Data
(60) Provisional application No. 61/139,732, filed on Dec. 22, 2008.
(60) Provisional application No. 61/145,809, filed on Jan. 20, 2009.
(60) Provisional application No. 61/165,564, filed on Apr. 1, 2009.

(51) Int. Cl. H02K 21/02; H02N 11/00

(52) U.S. Cl. 310/152; 415/916

(57) ABSTRACT

A magnet motor comprises a first ferromagnetic member and a second ferromagnetic member reciprocated in working direction relative to the first ferromagnetic member. A controller displaces a permanent magnet between an engaged position adjacent to the ferromagnetic members with the flux being perpendicular to the working direction and a disengaged position spaced from the first and second ferromagnetic members. The controller also displaces the second ferromagnetic member towards the first ferromagnetic member when the permanent magnet is in the disengaged position and captures energy from the resulting displacement of the first ferromagnetic member away from the second ferromagnetic member when the permanent magnet is in the engaged position.

This application claims the benefit under 35 U.S.C.119(e) of U.S. provisional application Ser. No. 61/139,732, filed Dec. 22, 2008; U.S. provisional application Ser. No. 61/145,809, filed Jan. 20, 2009; and U.S. provisional application Ser. No. 61/165,564, filed Apr. 1, 2009.

### FIELD OF THE INVENTION

The present invention relates to a magnet motor and related method of use of the magnet motor to produce usable energy, and more particularly relates to a magnet motor using permanent magnets to reciprocate an output member of the motor.

### BACKGROUND

U.S. Pat. No. 3,879,622 by Ecklin discloses one example of a motor which uses the energy stored in the fields of permanent magnets to produce work in order to satisfy needs for additional sources of energy. The permanent magnet motor in one embodiment utilizes a spring-biased reciprocating magnetizable member positioned between two permanent magnets. Magnetic shields in the form of rotatable shutters are located between each permanent magnet and the reciprocating member to alternately shield and expose the member to the magnetic field thereby producing reciprocating motion. As the shutters can only shield a very small magnetic field, the power extracted from the reciprocating member is very small and inadequate for displacing the shutters effectively to produce a net surplus of energy.

### SUMMARY OF THE INVENTION

According to one aspect of the present invention there is provided a magnet motor comprising:

a first ferromagnetic member;

a second ferromagnetic member supported for movement in a working direction relative to the first ferromagnetic member between a first position adjacent the first ferromagnetic member and a second position spaced apart from the first ferromagnetic member;

a driving magnet comprising a permanent magnet having a magnetic flux oriented in a flux direction from a first pole at a first end face of the magnet to a second pole at a second end face of the magnet;

the driving magnet being movable relative to the first ferromagnetic member between an engaged position in which the driving magnet is supported in proximity to the first and second ferromagnetic members and the flux direction is oriented substantially perpendicularly to the working direction of the second ferromagnetic member and a disengaged position in which the driving magnet is positioned farther from the first and second ferromagnetic members than in the engaged position; and

a controller arranged to alternately position the driving magnet between the engaged position and the disengaged position thereof;

the controller being further arranged to displace the second ferromagnetic member from the second position to the first position when the driving magnet is in the disengaged position; and

the controller being further arranged to capture energy from displacement of the ferromagnetic member from the first position to the second position when the driving magnet is in the engaged position.

In one preferred embodiment the driving magnet comprises a first movable magnet and there is provided an additional driving magnet comprising a second movable magnet. Also in the preferred embodiment, the second movable magnet comprises a permanent magnet having a magnetic flux oriented in a flux direction from a first pole at a first end face of the magnet to a second pole at a second end face of the magnet; the second movable magnet being movable relative to the first ferromagnetic member between an engaged position in which the second movable magnet is supported in proximity to the first and second ferromagnetic members and the flux direction is oriented substantially perpendicularly to the working direction of the second ferromagnetic member in alignment with the flux direction of the first movable magnet and a disengaged position in which the driving magnet is positioned farther from the first and second ferromagnetic members than in the engaged position thereof; and the controller being arranged to reciprocate both the first and second movable magnets between the engaged position and the disengaged position thereof.

The first and second movable magnets may be movable together between the engaged and disengaged positions thereof.

The first and second movable magnets may be movable between the engaged and disengaged positions thereof in a common direction oriented perpendicularly to the flux directions thereof.

The first and second movable magnets may be supported spaced apart from one another in the flux direction in the engaged position of the magnets on opposing sides of the ferromagnetic members received therebetween.

The first and second ferromagnetic members may comprise flat plate members lying parallel to one another in respective planes oriented parallel to the flux directions of the movable magnets in which each of the plate members spans between opposing side edges in proximity to the first and second permanent magnets in the engaged position respectively.

The first and second ferromagnetic members may comprise flat plate members lying parallel to one another and being substantially perpendicular to the working direction.

The first and second ferromagnetic members may comprise flat plate members which are elongate in a direction of movement of the driving magnet.

The controller may be further arranged to capture energy from the displacement of the driving magnet from the disengaged position to the engaged position; to sequence movements of the second ferromagnetic member and the driving magnet; and to transfer energy as required to sustain reciprocation of the second ferromagnetic member and the driving magnet.

There may be provided a first fixed magnet comprising a permanent magnet supported in fixed relation to the first ferromagnetic member and having a magnetic flux oriented parallel and in alignment with the flux direction of the driving magnet in the engaged position.

The first fixed magnet and the driving magnet may be spaced apart in the flux direction on opposing sides of first ferromagnetic member.

The first and second ferromagnetic members may span one of the end faces of the driving magnet in the engaged position.

There may be provided a first fixed magnet and a second fixed magnet in which each fixed magnet comprises a permanent magnet supported in fixed relation to the first ferromagnetic member and having a magnetic flux oriented parallel and in alignment with the flux direction of the driving magnet in the engaged position, the first and second fixed magnets being supported spaced apart in the flux direction on opposing sides of the first ferromagnetic member.

The second fixed magnet may be received between first ferromagnetic member and the driving magnet in the engaged position of the driving magnet.

The working direction may be parallel to the end face of driving magnet which is nearest to the first ferromagnetic member.

The driving magnet may be movable between the engaged and disengaged positions thereof in a plane which substantially parallel to working direction.

The driving magnet may be movable between the engaged and disengaged positions thereof perpendicularly to the flux direction and perpendicularly to the working direction of the first and second ferromagnetic members.

The controller may be arranged to linearly reciprocate the driving magnet between the engaged position and the disengaged position thereof.

The first and second ferromagnetic members may be curved about a central axis in which the working direction is oriented radially in relation to the central axis and the driving magnet is movable in a tangential direction in relation to the central axis. The controller may be arranged to cyclically rotate the driving magnet between the engaged position and the disengaged position thereof.

According to another aspect of the invention there is provided a magnet motor comprising:

first and second permanent magnets, each having a magnetic flux oriented in a flux direction from a first pole at a first end of the magnet to a second pole at a second end of the magnet respectively;

the first and second permanent magnets being oriented such that the respective flux directions are commonly directed in a longitudinal direction;

the first and second permanent magnets being supported spaced apart from one another in said longitudinal direction;

a ferromagnetic member supported between the first and second magnets so as to be arranged for movement in a first working direction oriented perpendicularly to the longitudinal direction between a first position in which the ferromagnetic member is substantially centered relative to first and second permanent magnets in the working direction and a second position in which the ferromagnetic member is offset from the first position in the working direction such that the ferromagnetic member is biased by the first and second permanent magnets from the second position towards the first position;

at least one auxiliary permanent magnet having a magnetic flux oriented in a flux direction from a first pole at a first end of the magnet to a second pole at a second end of the magnet;

said at least one auxiliary permanent magnet being supported for movement in a second working direction transverse to the longitudinal direction of the first and second permanent magnets between a first position adjacent one end of the first permanent magnet opposite from the second permanent magnet in which the flux direction is directed in the longitudinal direction and a second position offset from the first position in the lateral direction; and

a controller arranged to reciprocate said at least one auxiliary permanent magnet between the first position and the second position thereof;

the controller being further arranged to displace the ferromagnetic member from the first position to the second position when said at least one auxiliary permanent magnet is in the second position; and

the controller being further arranged to capture energy from displacement of the ferromagnetic member from the second position to the first position when said at least one auxiliary magnet is in the first position.

Preferably there is provided an energy storage mechanism arranged to store the energy captured from displacement of the ferromagnetic member from the second position to the first position when said at least one auxiliary magnet is in the first position.

The controller is preferably arranged to use energy stored by the energy storage mechanism both to reciprocate said at least one auxiliary permanent magnet between the first position and the second position thereof and to displace the ferromagnetic member from the first position to the second position when said at least one auxiliary permanent magnet is in the second position.

The invention utilizes the attractive force between two magnetically different systems which when they interact generate and the resulting repulsive forces generated between two plates in one of the magnetic systems, when the two systems are moved in relation to one another as illustrated in the figures here within.

The first magnetic system is composed of two permanent magnets and two plates. The two magnets are separated at a fixed distance with the plates oriented between the permanents magnets. One plate is not moveable and is at a fixed distance between the permanent magnets. The second plate is at a fixed distance between the two magnets however it is allowed to move when repulsed by the other plate at a constant distance between the two permanent magnets.

The second magnetic system is composed of two magnets one with a higher flux density than the permanent magnets contained in the first magnetic system.

It is the magnetic interaction between these two systems and the resulting repulsive forces between the plates, contained in only one magnetic system, which allows the energy in the permanent magnets to be utilized as useable power to the power source.

According to a further aspect of the present invention there is provided a method of producing usable energy comprising:

providing first and second permanent magnets, each having a magnetic flux oriented in a flux direction from a first pole at a first end of the magnet to a second pole at a second end of the magnet respectively;

orienting the first and second permanent magnets such that the respective flux directions are commonly directed in a longitudinal direction;

supporting the first and second permanent magnets spaced apart from one another in said longitudinal direction;

supporting a ferromagnetic member between the first and second magnets so as to be arranged for movement in a working direction oriented perpendicularly to the longitudinal direction between a first position in which the ferromagnetic member is substantially centered relative to first and second permanent magnets in the working direction and a second position in which the ferromagnetic member is offset from the first position in the working direction such that the ferromagnetic member is biased by the first and second permanent magnets from the second position towards the first position;

providing at least one auxiliary permanent magnet having a magnetic flux oriented in a flux direction from a first pole at a first end of the magnet to a second pole at a second end of the magnet;

supporting said at least one auxiliary permanent magnet for movement in a lateral direction transverse to the longitudinal direction of the first and second permanent magnets between a first position adjacent one end of the first permanent magnet opposite from the second permanent magnet in which the flux direction is directed in the longitudinal direction and a second position offset from the first position in the lateral direction;

reciprocating said at least one auxiliary permanent magnet between the first position and the second position thereof;

displacing the ferromagnetic member from the first position to the second position when said at least one auxiliary permanent magnet is in the second position; and

capturing energy from the ferromagnetic member as the ferromagnetic member is biased from the second position to the first position when said at least one auxiliary magnet is in the first position.

Some embodiments of the invention will now be described in conjunction with the accompanying drawings in which:

### BRIEF DESCRIPTION OF THE DRAWINGS

FIGS. 1A, 1B and 1C illustrate top, side and end views of the motor in a first portion of the cycle according to a first embodiment.

FIGS. 2A, 2B and 2C illustrate top, side and end views of the motor in a second portion of the cycle according to the first embodiment.

FIGS. 3A, 3B and 3C illustrate top, side and end views of the motor in a third portion of the cycle according to the first embodiment.

FIGS. 4A, 4B and 4C illustrate illustrates top, side and end views of the motor in a fourth portion of the cycle according to the first embodiment.

FIGS. 5A, 5B and 5C illustrate illustrates top, side and end views of the motor in a first portion of the cycle according to a second embodiment.

FIGS. 6A, 6B and 6C illustrate illustrates top, side and end views of the motor in a second portion of the cycle according to the second embodiment.

FIGS. 7A, 7B and 7C illustrate illustrates top, side and end views of the motor in a third portion of the cycle according to the second embodiment.

FIGS. 8A, 8B and 8C illustrate illustrates top, side and end views of the motor in a fourth portion of the cycle according to the second embodiment.

FIGS. 9A, 9B and 9C illustrate top, side and end views of the motor in a first portion of the cycle according to a third embodiment.

FIGS. 10A, 10B and 10C illustrate top, side and end views of the motor in a second portion of the cycle according to the third embodiment.

FIGS. 11A, 11B and 11C illustrate top, side and end views of the motor in a third portion of the cycle according to the third embodiment.

FIGS. 12A, 12B and 12C illustrate top, side and end views of the motor in a fourth portion of the cycle according to the third embodiment.

FIGS. 13A, 13B and 13C illustrate top, side and end views of the motor in a first portion of the cycle according to a fourth embodiment.

FIGS. 14A, 14B and 14C illustrate top, side and end views of the motor in a second portion of the cycle according to the fourth embodiment.

FIGS. 15A, 15B and 15C illustrate top, side and end views of the motor in a third portion of the cycle according to the fourth embodiment.

FIGS. 16A, 16B and 16C illustrate top, side and end views of the motor in a fourth portion of the cycle according to the fourth embodiment.

FIGS. 17A, 17B and 17C illustrate top, side and end views of the motor in a first portion of the cycle according to a fifth embodiment.

FIGS. 18A, 18B and 18C illustrate illustrates top, side and end views of the motor in a second portion of the cycle according to the fifth embodiment.

FIGS. 19A, 19B and 19C illustrate top, side and end views of the motor in a third portion of the cycle according to the fifth embodiment.

FIGS. 20A, 20B and 20C illustrate top, side and end views of the motor in a fourth portion of the cycle according to the fifth embodiment.

FIGS. 21A, 21B and 21C illustrate top, side and end views of the motor in a fourth portion of the cycle according to the sixth embodiment.

FIGS. 22A, 22B and 22C illustrate top, side and end views of the motor in a fourth portion of the cycle according to the seventh embodiment.

In the drawings like characters of reference indicate corresponding parts in the different figures.

### DETAILED DESCRIPTION

Referring to the accompanying figures there is illustrated a magnet motor generally indicated by reference numeral 10. The motor 10 uses the magnetic flux of permanent magnets acting on ferromagnetic material to reciprocate an output of the motor.

Although various embodiment of the motor are described and illustrated herein, the common features of the first two embodiments will first be described.

The motor 10 includes a first permanent magnet 12 and a second permanent magnet 14 which are fixed relative to one another. The magnets have the same dimensions and flux density as one another so that the magnitudes of the magnetic fluxes of the magnets are identical to one another also. Each magnet extends in a longitudinal direction from a first end 16 to a second end 18. The flux is oriented in a flux direction extending between a first pole at the first end 16 and a second pole at the second end 18.

Each of the first and second permanent magnets also comprises four boundary walls 20 extending in the longitudinal direction between the first and second ends parallel to the flux direction. The boundary walls form a generally rectangular perimeter about the body of the magnet which extends in the longitudinal or flux direction. The body of the magnet is elongate in a lateral direction oriented perpendicularly to the longitudinal direction. The boundary walls thus include two opposed long sides extending in the lateral direction and two opposed short sides extending between the long sides.

The first and second permanent magnets are positioned fixed relative to one another so that the longitudinal direction thereof are aligned and more particularly so that the flux directions of the two magnets extend commonly on the longitudinal direction in alignment with one another but spaced apart from one another in the longitudinal direction such that the permanent magnets are substantially centered with one another along the longitudinal axis. The space between the first and second permanent magnets is approximately equal to the length of each one of the magnets in the longitudinal direction between the opposed first and second ends thereof.

The motor also includes a ferromagnetic base element 22 which is generally in the form of a flat plate formed of rolled steel sheet metal which is oriented to be parallel to the longitudinal flux direction of the first and second permanent magnets as well as being parallel to the elongate lateral direction of the magnets. The base element thus spans in width in the longitudinal direction a dimension corresponding approximately to the space between the first and second permanent magnets as well as spanning in length the lateral direction a length of the permanent magnets between the two short sides thereof. The ferromagnetic base element 22 is slightly shorter in the longitudinal direction than the space between the permanent magnets so as to be in close proximity to the two permanent magnets along the opposing edges thereof while remaining spaced therefrom so as not to be in contact with the permanent magnets. The base element 22 is positioned close to a long one of the boundary walls of the first and second permanent magnets so to be substantially flush along an outer side thereof.

The motor 10 also comprises a ferromagnetic member 24 which is supported for linear sliding movement relative to the first and second permanent magnets and relative to the ferromagnetic base element 22. The ferromagnetic member 24 comprises a flat plate formed of similar rolled steel sheet metal as the base element 22. The ferromagnetic member 24 is also similarly oriented to span similar dimensions of width and length and to lie parallel to both the longitudinal direction and the elongate lateral of the magnets, so as also to be parallel to the base element 22.

The ferromagnetic member 24 is moveable in a first working direction which is perpendicular to the flat plane of the member 24 as well as being perpendicular to the longitudinal direction and lateral direction of the motor. The member 24 is moveable between a first position which is centered relative to the boundary walls of the first and second permanent magnets and a second position adjacent one of the long sides of the boundary walls of the magnets.

More particularly in the first position the ferromagnetic member 24 is centered relative to the magnetic flux of the first and second permanent magnets so as to be balanced centrally between the first and second magnets by the magnetic attraction of the ferromagnetic member to the two magnets.

In the second position the ferromagnetic member 24 is offset and spaced in the first working direction from the location of the member 24 in the first position to be positioned adjacent the boundary wall locating the base element 22 adjacent thereto. Accordingly in the second position the ferromagnetic member 24 is biased towards the first position thereof by the magnetic force from the first and second permanent magnets as well as being repelled from the induced magnetized forces within the ferromagnetic base element 22 by the action of the first and second permanent magnets.

The movement of the ferromagnetic member 24 from the second position to the first position comprises the output of the magnet motor 10. The energy of this movement is captured by a suitable energy storage mechanism of a controller of the motor. For example there may be provided an electric generator which is driven by the movement of the ferromagnetic member from the second position to the first position with the electricity generated thereby being stored in an electric battery for subsequent use as may be desired.

The motor 10 further comprises at least one auxiliary permanent magnet 26 which is similarly configured as the first and second permanent magnets so as to have a magnetic flux which extends in a flux direction from a first pole at a first end 28 to a second pole at a second end 30. The auxiliary permanent magnet 26 further comprises boundary walls 32 in a rectangular configuration to comprise two opposed long sides and two opposed short sides which extend parallel to the flux direction between the opposed ends of the magnet. The two long sides are much longer than the two short sides so that the auxiliary permanent magnet is similarly elongate in the lateral direction perpendicular to the longitudinal direction which all of the flux directions are aligned with. The dimensions of the auxiliary permanent magnet are substantially identical as the first and second magnets.

The auxiliary permanent magnet 26 is supported for linear sliding movement in a second working direction parallel to the lateral direction of the motor so as to be perpendicular to both the longitudinal direction of the motor and the first working direction of the movement of the ferromagnetic member 24. The auxiliary permanent magnet 26 is moveable between a first position in which the magnetic flux thereof is aligned in the flux direction with the magnetic flux of the first and second permanent magnets and a second position in which the auxiliary permanent magnet is offset and spaced in the second working direction from the location of the auxiliary permanent magnet in the first position.

More particularly in the first position of the auxiliary permanent magnet 26, the magnet is abutted in end to end relationship with the first permanent magnet so that the second pole of the auxiliary permanent magnet is directly abutted with the first pole of the first permanent magnet and the flux direction is commonly oriented in the longitudinal direction. In this position the auxiliary permanent magnet serves to increase the magnitude of the flux of the first magnet which is apparent at the ferromagnetic member. The flux density is most affected when the auxiliary permanent magnet is positioned so that the boundary walls thereof are flush with the boundary walls of the first permanent magnet and the auxiliary permanent magnet is accordingly centered relative to the boundary walls of the first permanent magnet.

In the second position of the auxiliary permanent magnet the auxiliary permanent magnet is displaced in the second working direction or elongate lateral direction such that the magnet is fully offset from the first permanent magnet so that there is no overlap therebetween in the lateral direction. The magnetic flux of the first permanent magnet as felt by the moveable ferromagnetic member 24 is thus reduced as compared to the first position of the auxiliary permanent magnet.

The controller of the motor serves to reciprocate the auxiliary permanent magnet between the first and second positions thereof in use using the stored energy which is captured by the energy storage mechanism from the movement of the ferromagnetic member 24 from the second position to the first position thereof as biased by the magnetic forces of the first and second permanent magnets. More particularly the controller displaces the auxiliary permanent magnetic from the second position from the first position thereof once the ferromagnetic 24 reaches the first position thereof. Alternatively the controller displaces the auxiliary permanent magnet 26 to the first position thereof once the moveable ferromagnetic member 24 is in the second position thereof.

The controller also serves to displace the ferromagnetic member 24 from the first position to the second position thereof once the auxiliary permanent magnet 26 is in the second position, similarly using stored energy captured by the energy storage mechanism of the controller.

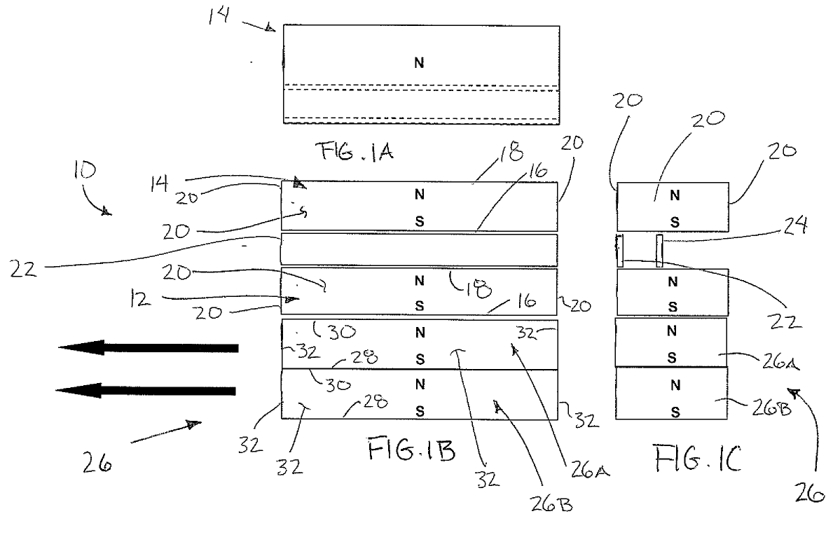

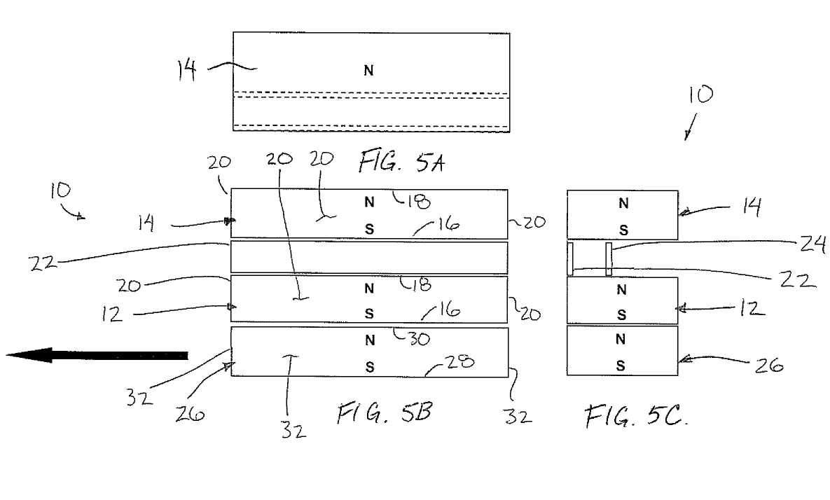

In use the motor 10 is initially positioned in a first operating position as shown in FIGS. 1 and 5 in which both the auxiliary permanent magnet and the ferromagnetic member are in the respective first positions thereof. In the first cycle of operation, the auxiliary permanent magnet is displaced into the second position thereof.

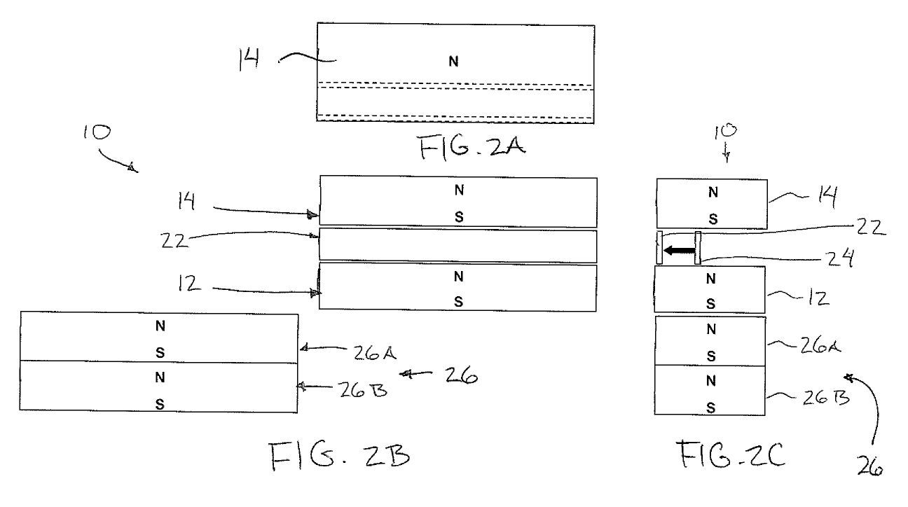

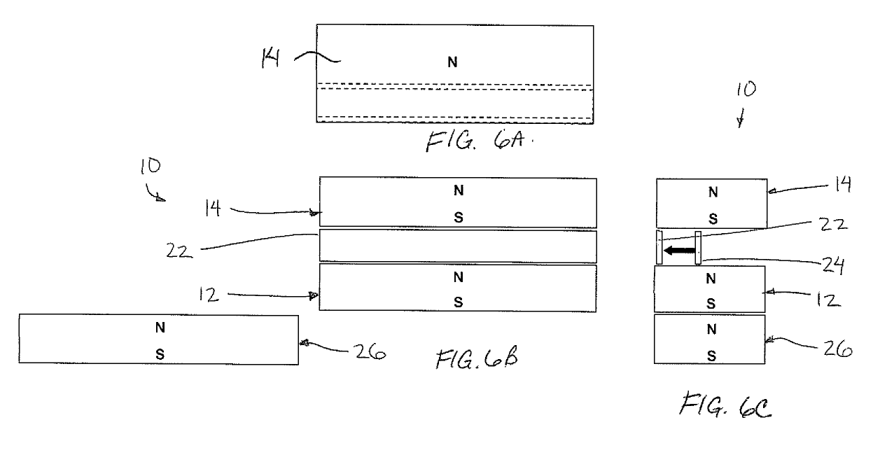

Upon completion of the first cycle, the motor reaches the second operating position as shown in FIGS. 2 and 6. Once the auxiliary permanent magnet reaches the second position thereof, the second cycle of the motor involves the ferromagnetic member being displaced from the first position into the second position thereof while the auxiliary permanent member remains in the second position thereof.

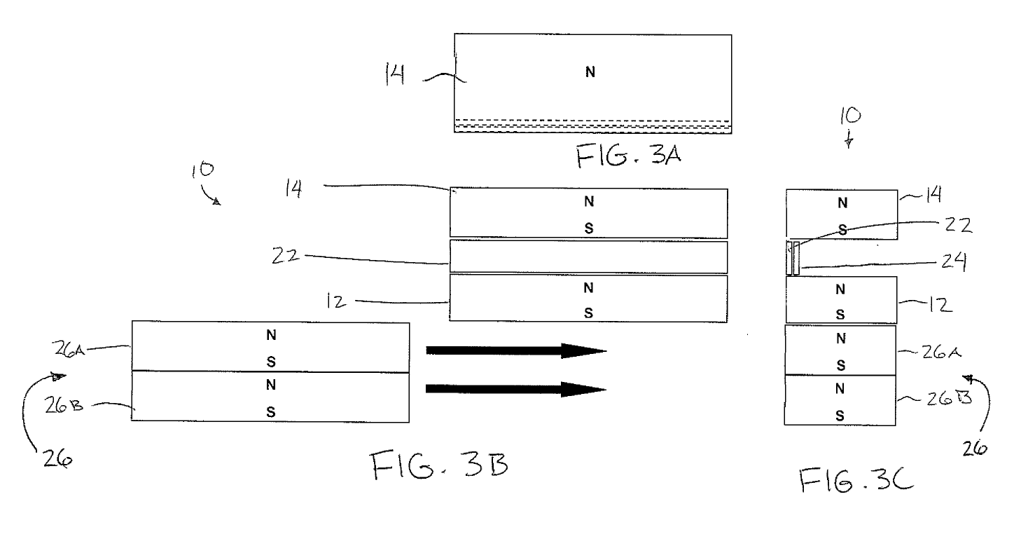

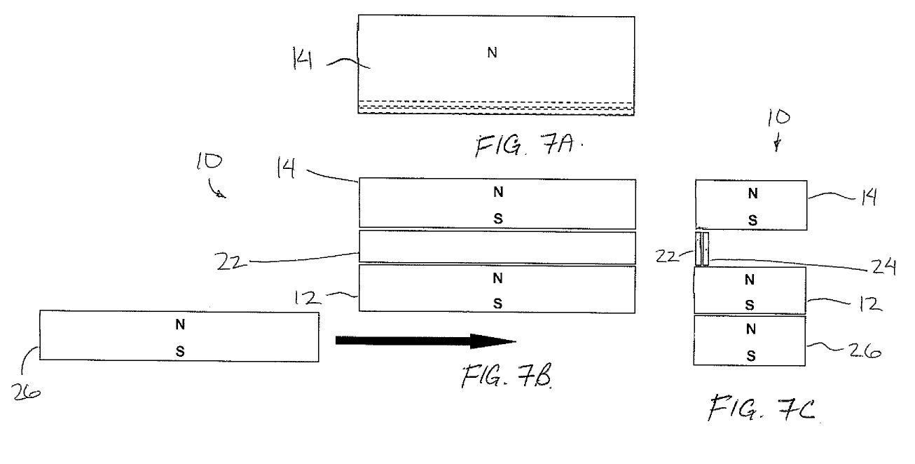

The motor thus reaches the third operating position as shown in FIGS. 3 and 7. The third cycle begins when the third operating position is reached and involves displacement of the auxiliary permanent magnet returning from the second position to the first position.

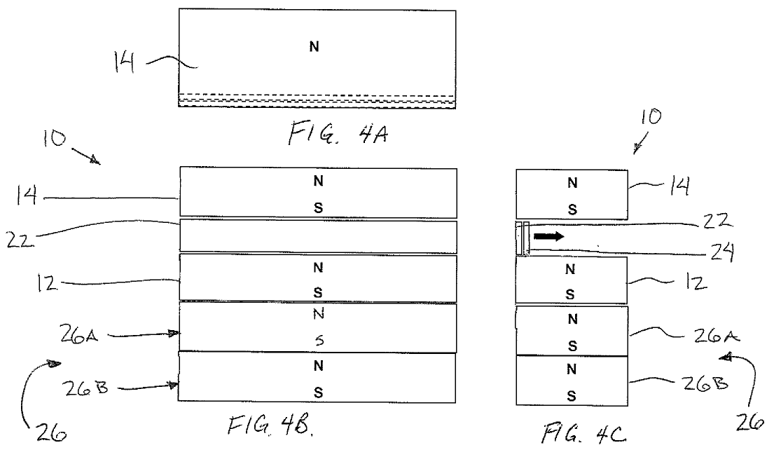

Upon the auxiliary permanent magnet returning to the first position the motor reaches the fourth operating position shown in FIGS. 4 through 8. The fourth cycle of the motor then involves the ferromagnetic member being permitted to return from the second position to the first position under action of the permanent magnets biasing the ferromagnetic member back to the first position which provides the driving force for the remaining cycles of the motor.

Turning now more particularly to the embodiments of FIGS. 1 through 4, the at least one auxiliary permanent magnet 26 comprises a first auxiliary magnet 26A and a second auxiliary magnet 26B. The two auxiliary magnets 26A and 26B are abutted with one another in an end to end configuration so that the magnet flux is in a common flux direction in the longitudinal direction in first position thereof. The two magnets are moveable together between the first and second positions thereof. The first auxiliary magnet 26A which is closest to the first permanent magnet for direct abutment therewith in the first position has a magnitude of magnetic flux which is substantially equal to the magnitude of the magnetic flux of either one of the first or second permanent magnets. The other permanent magnet 26B farthest from the first permanent magnet has a magnitude of magnetic flux which is greater than either one of the first and second permanent magnets so that the two auxiliary magnets 26A and 26B combined have an overall magnetic flux with a magnitude which is greater than the combined magnetic flux of the first and second permanent magnets.

Turning now more particularly to the embodiment of FIGS. 5 through 8, there is provided only a single auxiliary permanent magnet 26 for movement between the first and second positions. In this instance the flux magnitude of the magnet 26 by itself is typically greater than the flux magnitude of either one of the first or second permanent magnets.

As described above, according to the first embodiment the permanent magnet field energy conversion device converts the magnetic field energy contained in and around permanent magnets into mechanical energy, without any external inputs. This device is composed of two assemblies, the plate carrier, the flux driver and a moveable output plate.

### Plate Carrier Assembly

The plate carrier assembly is composed of 2 ceramic permanent magnets and are separated from each other at a fixed distance with the pole faces parallel and attracting each other. Located between the plate carrier magnets is a stationary ferromagnetic plate. This fixed plate is oriented perpendicular between the carrier magnets, is flush to the outside edge of the carrier magnets, with the thinnest edges of the plate perpendicular to the pole faces of the carrier magnets, does not touch either of the carrier magnets and conducts magnetic flux from one carrier magnet to the other.

### Output Plate

Also located between the plate carrier magnets is the output plate. The output plate is oriented adjacent and parallel to the fixed plate and conducts flux between the two carrier magnets. The output plate is allowed to move away from the fixed plate further into the magnetic flux between the carrier magnets pole faces, and is not allowed to contact either of the carrier magnet pole faces while it moves.

### Flux Driver Assembly

The flux driver assembly is made up of two permanent magnets, 26A and 26B. These two permanent magnets are placed together with poles attracting and will be held to each other by their attractive force. The flux density of magnet 26A is larger than the flux density in magnet 26B. The flux density of magnets 20 is the same or less than the flux density of 26A. The flux driver permanent magnets are located next to a carrier permanent magnet with the pole face of 26A parallel and attracted by 20. The flux driver assembly is allowed to move in a plane parallel to and not touching the pole face of item 13.

### Device Operation

Cycle 1—In cycle 1 (FIG. 1) the flux driver assembly are removed from the attractive forces generated by 20. The energy needed for this movement was obtained from the energy created and stored in cycle 3 by the movement of magnets 26A and 26B (FIG. 3).

Cycle 2—In cycle 2 (FIG. 2) the output plate is forced back adjacent to the fixed plate item 22. The energy needed for this movement was obtained from the energy created and stored in cycle 4 by the movement of item 24. The energy created in cycle 4 is much larger than that used in cycle 2, this is due to the larger flux density between the carrier magnets from the presence of magnets 26A and 26B.

Cycle 3—In cycle 3 (FIG. 3) the flux driver assembly magnets 26A and 26B is attracted by the pole face of magnet 20. The energy created by this movement is equal to the energy used in cycle one (FIG. 1).

Cycle 4—In cycle 4 (FIG. 4) the output plate and fixed plate repulse each other, thus creating work. The energy created in cycle 4 is much larger than that used in cycle 2, this is due to the larger flux density between the carrier magnets 20 from the presence of magnets 26A and 26B. It is the difference between the work in cycle 1 and cycle 4 that liberates work that can be utilized as an energy source.

As described above according to the second embodiment, the permanent magnet field energy conversion device also converts the magnetic field energy contained in and around permanent magnets into mechanical energy, without any external inputs. This device is composed of two assemblies, the plate carrier, the flux driver and a moveable output plate.

Plate Carrier Assembly The plate carrier assembly is composed of 2 ceramic permanent magnets 20 and are separated from each other at a fixed distance with the pole faces parallel and attracting each other. Located between the plate carrier magnets is a stationary ferromagnetic plate. This fixed plate is oriented perpendicular between the carrier magnets, is flush to the outside edge of the carrier magnets, with the thinnest edges of the plate perpendicular to the pole faces of the carrier magnets, does not touch either of the carrier magnets and conducts magnetic flux from one carrier magnet to the other.

### Output Plate

Also located between the plate carrier magnets is the output plate. The output plate is oriented adjacent and parallel to the fixed plate and conducts flux between the two carrier magnets. The output plate is allowed to move away from the fixed plate further into the magnetic flux between the carrier magnets pole faces, and is not allowed to contact either of the carrier magnet pole faces while it moves.

### Flux Driver Assembly

The flux driver assembly is made up of magnets 26. These magnets are placed together with poles attracting and will be held to each other by their attractive force. The flux driver permanent magnet is located next to a carrier permanent magnet with the pole face of item 26 parallel and attracted by item 12. The flux driver is allowed to move in a plane parallel to and not touching the pole face of item 12.

### Device Operation

Cycle 1—In cycle 1 (FIG. 5) the flux driver (item 26) is removed from the attractive forces generated by item 12. The energy needed for this movement was obtained from the energy created and stored in cycle 3 by the movement of item 26 (FIG. 7).

Cycle 2—In cycle 2 (FIG. 6) the output plate is forced back adjacent to the fixed plate item 22. The energy needed for this movement was obtained from the energy created and stored in cycle 4 by the movement of item 24. The energy created in cycle 4 is much larger than that used in cycle 2, this is due to the larger flux density between the carrier magnets from the presence of item 26.

Cycle 3—In cycle 3 (FIG. 7) the flux driver is attracted by the pole face of item 12. The energy created by this movement is equal to the energy used in cycle one (FIG. 5).

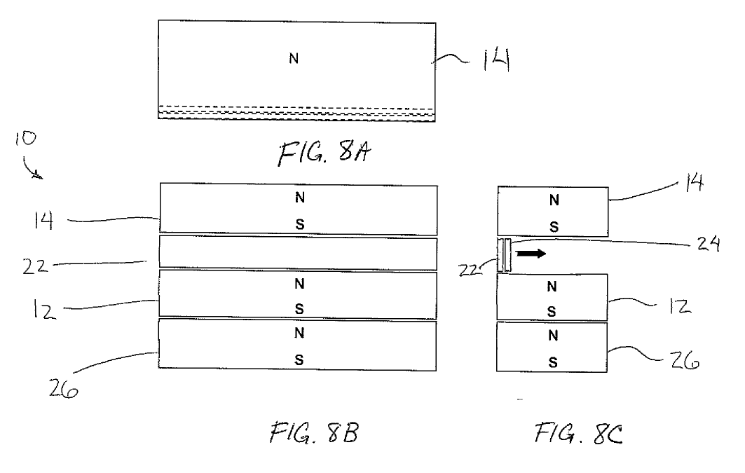

Cycle 4—In cycle 4 (FIG. 8) the output plate and fixed plate repulse each other, thus creating work. The energy created in cycle 4 is much larger than that used in cycle 2, this is due to the larger flux density between the carrier magnets from the presence of item 26. It is the difference between the work in cycle 1 and cycle 4 that liberates work that can be utilized as an energy source.

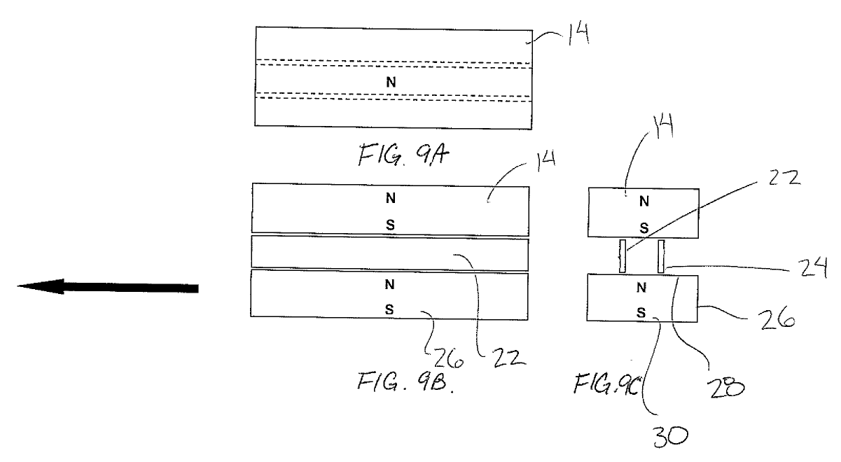

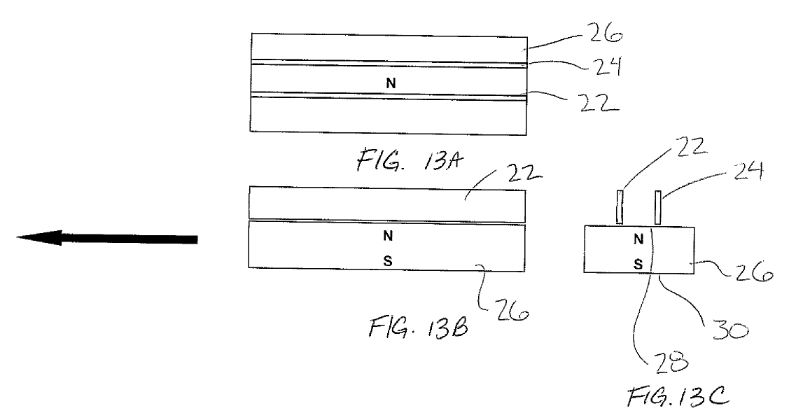

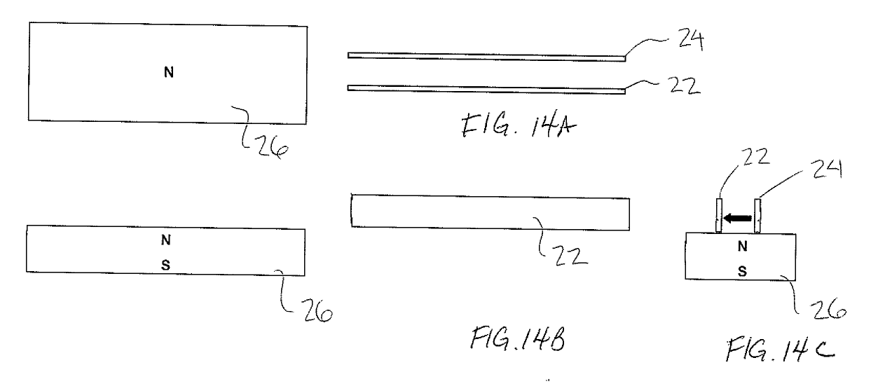

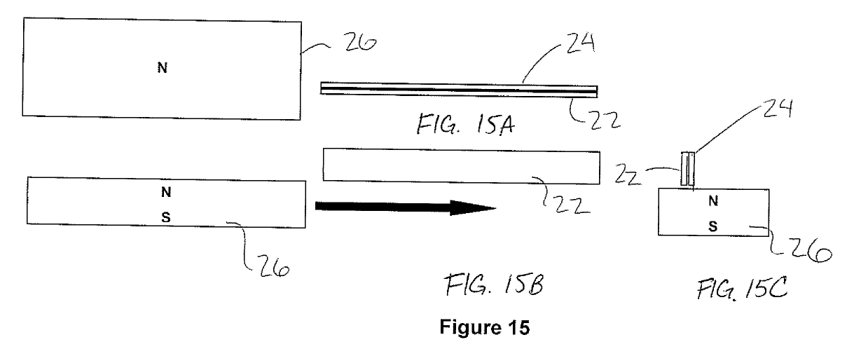

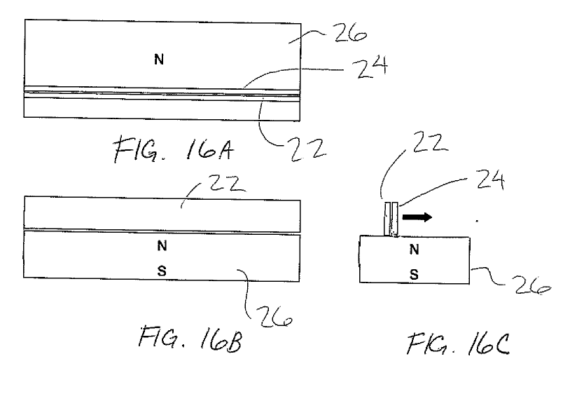

Turning now to the common features of the third embodiment of FIGS. 9 through 12, and the fourth embodiment of FIGS. 13 through 16, a magnet motor 10 is again described and illustrated herein. In this instance the ferromagnetic base element 22 comprises a first ferromagnetic member which is fixed in location. The movable ferromagnetic member 24 comprises a second ferromagnetic member supported for movement in the working direction between a first position adjacent the first ferromagnetic member and a second position spaced apart from the first ferromagnetic member.

The auxiliary permanent magnet 26 in this instance comprises a driving magnet which is a permanent magnet as in the previous embodiment having a magnetic flux oriented in a flux direction from a first pole at a first end face 28 of the magnet to a second pole at a second end face 30 of the magnet. The driving magnet 26 is again movable relative to the first ferromagnetic member between an engaged position in which the driving magnet is supported in proximity to the first and second ferromagnetic members and the flux direction is oriented substantially perpendicularly to the working direction of the second ferromagnetic member and a disengaged position in which the driving magnet is positioned farther from the first and second ferromagnetic members than in the engaged position.

As illustrated, the first and second ferromagnetic members span one of the end faces of the driving magnet in the engaged position. The working direction of the first ferromagnetic member is parallel the end faces of the driving magnet and the plane of movement of the driving magnet.

As in the previous embodiment, a controller captures the energy between the second (disengaged) position and first (engaged) position of the driving magnet and uses this energy to drive the magnet between the first position and the second position thereof. The controller also functions to displace the second ferromagnetic member from the second position to the first position when the driving magnet is in the disengaged position and to capture energy from displacement of the ferromagnetic member from the first position to the second position when the driving magnet is in the engaged position. The controller further functions to transfer energy as required to sequence and sustain reciprocation of the second ferrite member and the driving magnet.

The third embodiment of FIGS. 9 through 12 differs from the fourth embodiment in that there is also provided a first fixed permanent magnet 14 which has a flux direction oriented parallel and in alignment with the flux direction of the driving magnet in the engaged position. The first permanent magnet 14 is fixed relative to the first ferromagnetic member and is spaced from the driving magnet in the flux direction so that the first permanent magnet and the driving magnet are situated on opposing sides of first ferromagnetic member.

With further reference to the embodiment of FIGS. 9 through 12, the permanent magnet field energy conversion device converts the magnetic field energy contained in and around permanent magnets into mechanical energy, without any external inputs. This device is composed of two assemblies, the plate carrier, the flux driver and a moveable output plate.

The plate carrier assembly is composed of one permanent magnet. Located perpendicular to the plate carrier magnet is a stationary ferromagnetic plate. This fixed plate is oriented perpendicular to the carrier magnet, is located in from the edge of the carrier magnet, is perpendicular to the pole face of the carrier magnet, does not touch the carrier magnet or the driver magnet and conducts magnetic flux from the carrier magnet to the driver magnet.

The output plate is oriented adjacent and parallel to the fixed plate and conducts flux between the carrier and driver magnets. The output plate is allowed to move away from the fixed plate further into the magnetic flux between the carrier and flux driver magnet pole faces and is not allowed to contact either of the carrier magnet pole faces.

The flux driver magnet is a permanent magnet with a flux density that is considerably larger than the flux density of the carrier magnet. The flux driver magnet is attracted by the carrier magnet, is parallel the carrier magnet and is at a fixed distance from the carrier magnet. The flux driver magnet is allowed to move in a plane parallel to the pole face of item 14, does not touch the stationary plate or the moveable plate.

Operation of the Device Comprises Four Cycles as Follows:

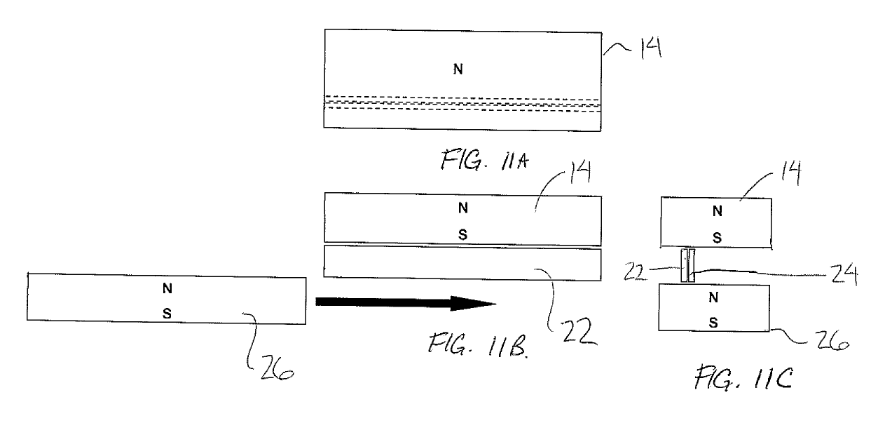

In cycle 1 (FIG. 9) the driver magnet is removed from the attractive forces generated by the carrier magnet. The energy needed for this movement was obtained from the energy created and stored in cycle 3 by the movement of item 26 (FIG. 11).

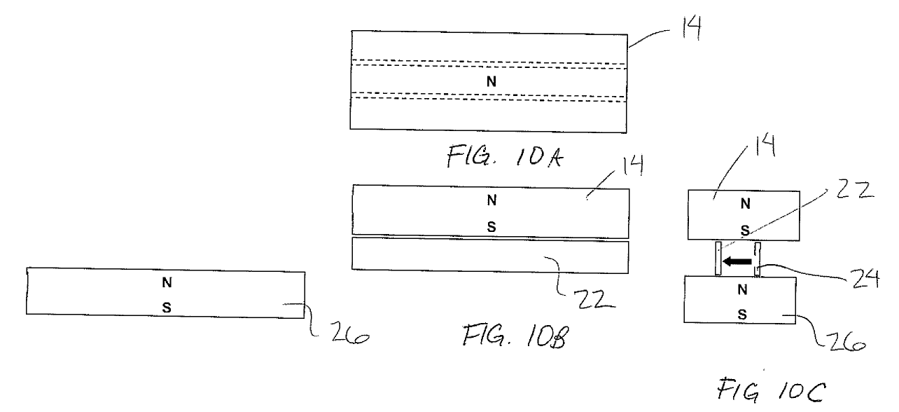

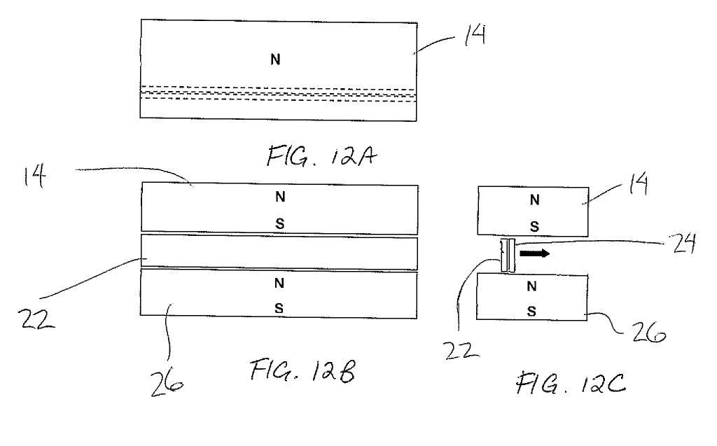

In cycle 2 (FIG. 10) the output plate is forced back adjacent to the fixed plate item 22. The energy needed for this movement was obtained from the energy created and stored in cycle 4 by the movement of the movable ferromagnetic member (FIG. 12). The energy created in cycle 4 is much larger than that used in cycle 2, this is due to the larger flux density from the presence of the magnet 26.

In cycle 3 (FIG. 11) the flux driver magnet is attracted by both the pole face of the carrier magnet and by the fixed and stationary plates conducting a portion of the flux between the flux driver magnet and the carrier magnet. The energy created by this movement is equal to the energy used in cycle one (FIG. 9).

In cycle 4 (FIG. 12) the output plate and fixed plate repulse each other, thus creating work. The energy created in cycle 4 is much larger than that used in cycle 2, this is due to the larger flux density from the presence of the magnet 26. It is the difference between the work in cycle 1 and cycle 4 that liberates work that can be utilized as an energy source.

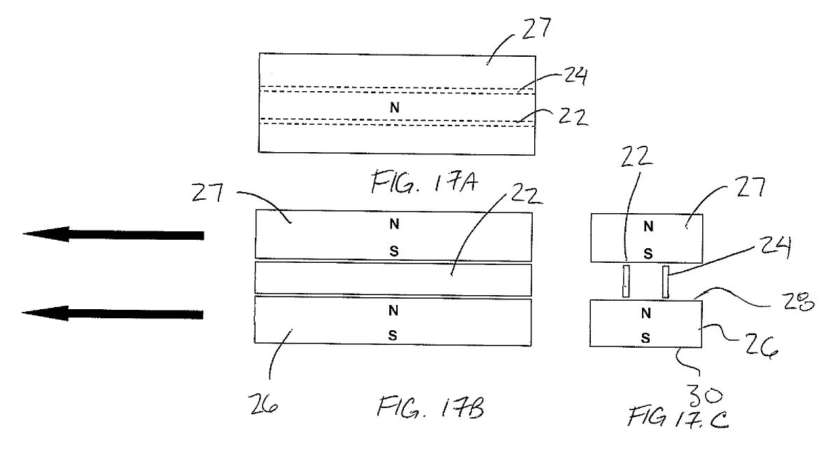

Turning now to FIGS. 17 through 20, a magnet motor 10 is again described and illustrated herein. Similarly to the embodiment of FIGS. 13-16, in this instance the ferromagnetic base element 22 comprises a first ferromagnetic member which is fixed in location and the movable ferromagnetic member 24 comprises a second ferromagnetic member supported for movement in the working direction between a first position adjacent the first ferromagnetic member and a second position spaced apart from the first ferromagnetic member.

The auxiliary permanent magnet 26 in this instance comprises a driving magnet or first movable magnet which is a permanent magnet as in the previous embodiment having a magnetic flux oriented in a flux direction from a first pole at a first end face 28 of the magnet to a second pole at a second end face 30 of the magnet.

This embodiment differs from the previous embodiment in that there is provided an additional driving magnet or second movable magnet 27 which also has a magnetic flux oriented in a flux direction from a first pole at a first end face 28 of the magnet to a second pole at a second end face 30 of the magnet.

The first movable magnet 26 and the second movable magnet 27 are both movable together to reciprocate under control of the controller. Both magnets 26 and 27 are movable relative to the first ferromagnetic member between an engaged position in which the magnets are supported in proximity to the first and second ferromagnetic members on opposing sides of the ferromagnetic members and the flux directions are oriented in a common direction in alignment with one another substantially perpendicularly to the working direction of the second ferromagnetic member and a disengaged position in which the first and second movable magnets are positioned farther from the first and second ferromagnetic members than in the engaged position. The first and second permanent magnets are movable between the engaged and disengaged positions thereof in a common direction oriented perpendicularly to the flux directions thereof.

In the engaged position, the first and second movable magnets are supported spaced apart from one another in the common flux direction thereof on opposing sides of the ferromagnetic members received therebetween. More particularly, the first and second ferromagnetic members comprise flat plate members as in the previous embodiments, which lie parallel to one another in respective planes oriented perpendicularly to the working direction such that the plates are parallel to the flux directions of the movable magnets and such that each of the plate members spans between opposing side edges thereof which are in close proximity adjacent to the first and second permanent magnets respectively. The first and second ferromagnetic members are elongate in a direction of movement of the driving magnet.

Subsequent to the engaged position, the first and second movable magnets 26 and 27 are movable together generally perpendicularly to the working direction of the second ferromagnetic member towards the disengaged position such that in the disengaged position, the first and second movable magnets are spaced from the first and second ferromagnetic members. The flux directions of the first and second movable magnets remain aligned with one another, perpendicular to the direction of movement of the magnets as the magnets are displaced to the disengaged position. The magnets in the disengaged position are situated laterally outwardly in the direction of movement thereof beyond the ends of the first and second ferromagnetic members.

In the embodiment of FIGS. 17-20, the plate assembly is composed of a stationary ferromagnetic plate and a moveable ferromagnetic output plate as described above. The stationary plate is oriented perpendicular to the carrier magnet; is located in from the edge of the carrier magnet; is perpendicular to the pole face of the carrier magnet; does not touch the carrier magnet or the driver magnet; and conducts magnetic flux from the carrier magnet to the driver magnet.

The output plate is oriented adjacent and parallel to the fixed plate. The fixed plate and the output plate both conduct flux between the carrier magnet and driver magnet. The output plate is allowed to move away from the fixed plate further into the magnetic flux between the carrier and flux driver magnet pole faces and is not allowed to contact the carrier magnet pole face or the output magnet pole face.

The flux driver magnet and carrier magnet assembly is made up of the flux driver magnet and the carrier magnet. The flux driver magnet is a permanent magnet with a flux density that is equal to or considerably larger than the flux density of the carrier magnet. The flux driver magnet is attracted by the other magnet, is parallel to the carrier magnet and is at a fixed distance from the carrier magnet. The flux driver magnet and the carrier magnet are allowed to move in a plane parallel to the pole faces of each other, are parallel to the plates and do not touch the stationary plate or the moveable plate.

The operation of the device according to FIGS. 17 to 20 comprises the following operations.

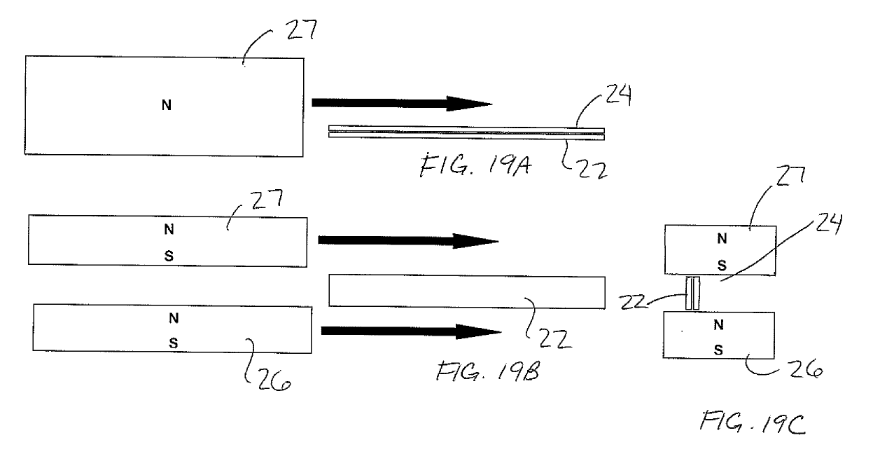

Cycle 1—In cycle 1 (FIG. 17) the driver magnet and carrier magnet are removed from the output and stationary plates. The energy needed for this movement was obtained from the energy created and stored in cycle 3 by the movement of the plates (FIG. 19).

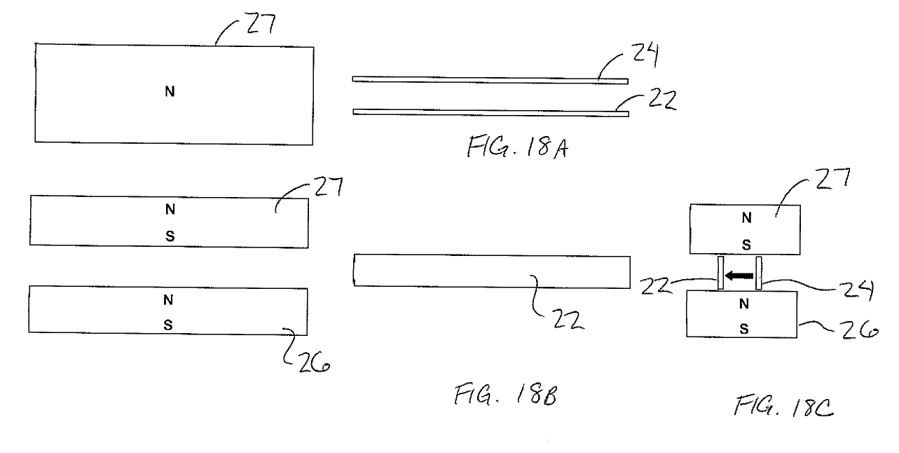

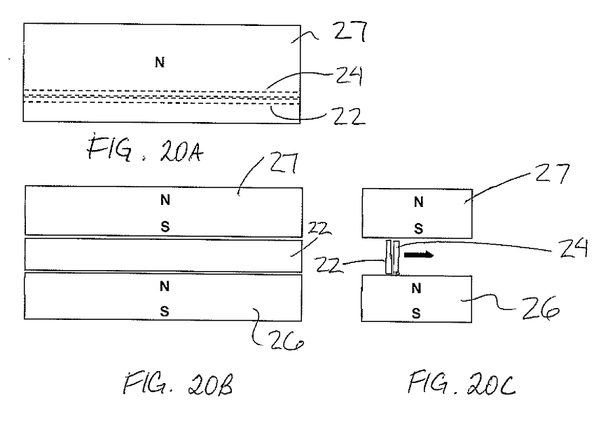

Cycle 2—In cycle 2 (FIG. 18) the output plate is forced back adjacent to the fixed plate item 22. The energy needed for this movement was obtained from the energy created and stored in cycle 4 by the movement of the movable ferromagnetic plate (FIG. 20). The energy created in cycle 4 is much larger than that used in cycle 2. This is due to the larger flux density from the presence of magnets 26 and 27.

Cycle 3—In cycle 3 (FIG. 19) the flux driver magnet and carrier magnet are attracted by both the output and stationary plates. The energy created by this movement is equal to the energy used in cycle one (FIG. 17).

Cycle 4—In cycle 4 (FIG. 20) the output plate and fixed plate repulse each other, thus creating work. The energy created in cycle 4 is much larger than that used in cycle 2. This is due to the larger flux density from the presence of magnets 26 and 27. It is the difference between the work in cycle 1 and cycle 4 that liberates work that can be utilized as an energy source.

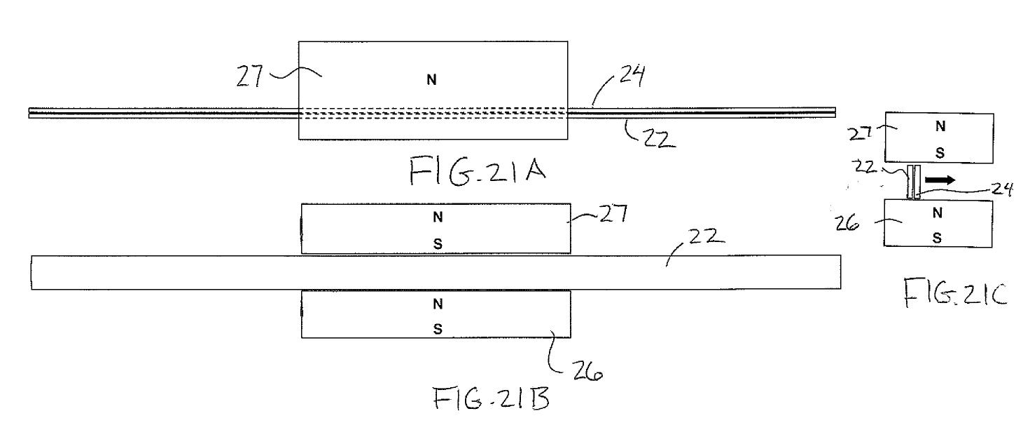

Turning now to FIG. 21, a further embodiment of the magnet motor 10 is illustrated in the fourth cycle thereof which is substantially identical and operates identically to the embodiment of FIGS. 17 through 20 with the exception of the fixed ferromagnetic member 22 and the movable ferromagnetic member 24 which are arranged to extend longitudinally beyond the ends of the adjacent magnets in the elongate direction of the plates and the permanent magnets instead of the ends of the ferromagnetic members being even with the ends of the permanent magnets as in the previous embodiments.

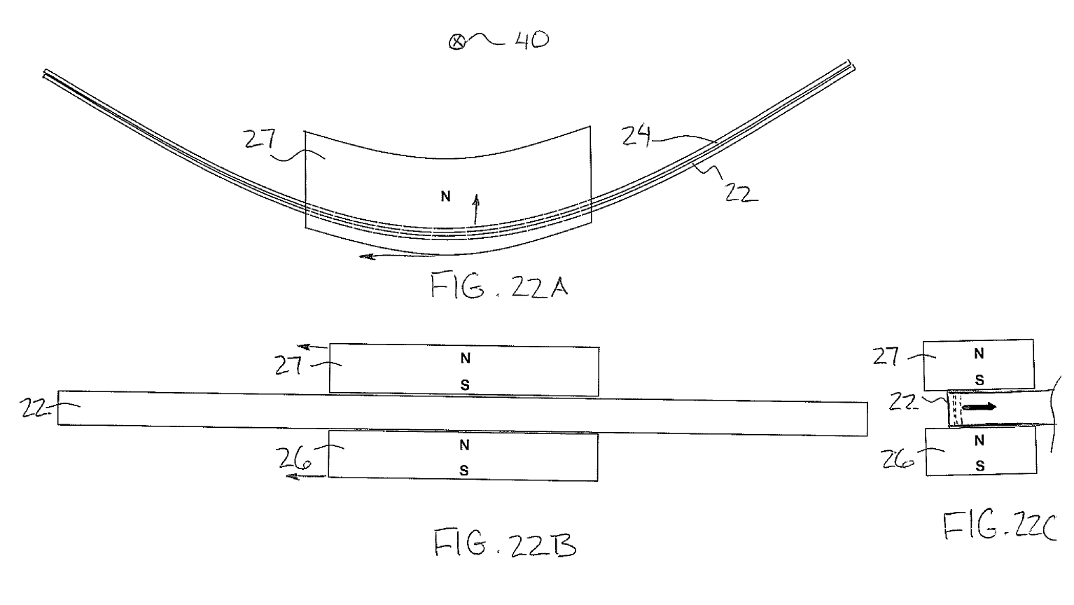

A further embodiment of the magnet motor 10 is shown in the fourth cycle thereof in FIG. 22. In this instance the magnet motor 10 is substantially identical to the embodiment of FIG. 21 with the exception of the fixed ferromagnetic member 22 and the movable ferromagnetic member 24 being substantially curved about a central axis 40. The movable ferromagnetic member is shown to be movable relative to the fixed ferromagnetic member 22 in the working direction which is oriented radially in relation to the central axis. The driving magnets 26 and 27 are thus movable in a tangential direction in relation to the central axis so that the driving magnets can be cyclically rotated about the central axis between the engaged positions and the disengaged positions of the driving magnets.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A magnet motor comprising:
a first ferromagnetic member;
a second ferromagnetic member supported for movement in a working direction relative to the first ferromagnetic member between a first position adjacent the first ferromagnetic member and a second position spaced apart from the first ferromagnetic member;
a driving magnet comprising a permanent magnet having a magnetic flux oriented in a flux direction from a first pole at a first end face of the magnet to a second pole at a second end face of the magnet;
the driving magnet being movable relative to the first ferromagnetic member between an engaged position in which the driving magnet is supported in proximity to the first and second ferromagnetic members and the flux direction is oriented substantially perpendicularly to the working direction of the second ferromagnetic member and a disengaged position in which the driving magnet is positioned farther from the first and second ferromagnetic members than in the engaged position; and
a controller arranged to alternately position the driving magnet between the engaged position and the disengaged position thereof;
the controller being further arranged to displace the second ferromagnetic member from the second position to the first position when the driving magnet is in the disengaged position; and
the controller being further arranged to capture energy from displacement of the ferromagnetic member from the first position to the second position when the driving magnet is in the engaged position.

2. The magnet motor according to claim 1 wherein the driving magnet comprises a first movable magnet and wherein there is provided an additional driving magnet comprising a second movable magnet;
the second movable magnet comprising a permanent magnet having a magnetic flux oriented in a flux direction from a first pole at a first end face of the magnet to a second pole at a second end face of the magnet;
the second movable magnet being movable relative to the first ferromagnetic member between an engaged position in which the second movable magnet is supported in proximity to the first and second ferromagnetic members and the flux direction is oriented substantially perpendicularly to the working direction of the second ferromagnetic member in alignment with the flux direction of the first movable magnet and a disengaged position in which the driving magnet is positioned farther from the first and second ferromagnetic members than in the engaged position thereof; and
the controller being arranged to reciprocate both the first and second movable magnets between the engaged position and the disengaged position thereof.

3. The magnet motor according to claim 2 wherein the first and second movable magnets are movable together between the engaged and disengaged positions thereof.

4. The magnet motor according to claim 2 wherein the first and second movable magnets are movable between the engaged and disengaged positions thereof in a common direction oriented perpendicularly to the flux directions thereof.

5. The magnet motor according to claim 2 wherein the first and second movable magnets are supported spaced apart from one another in the flux direction in the engaged position of the magnets on opposing sides of the ferromagnetic members received therebetween.

6. The magnet motor according to claim 2 wherein the first and second ferromagnetic members comprise flat plate members lying parallel to one another in respective planes oriented parallel to the flux directions of the movable magnets, each of the plate members spanning between opposing side edges in proximity to the first and second permanent magnets in the engaged position respectively.

7. The magnet motor according to claim 1 wherein the first and second ferromagnetic members comprise flat plate members lying parallel to one another and being substantially perpendicular to the working direction.

8. The magnet motor according to claim 1 wherein the first and second ferromagnetic members comprise flat plate members which are elongate in a direction of movement of the driving magnet.

9. The magnet motor according to claim 1 wherein the controller is further arranged to capture energy from the displacement of the driving magnet from the disengaged position to the engaged position; to sequence movements of the second ferromagnetic member and the driving magnet; and to transfer energy as required to sustain reciprocation of the second ferromagnetic member and the driving magnet.

10. The magnet motor according to claim 1 wherein there is provided a first fixed magnet comprising a permanent magnet supported in fixed relation to the first ferromagnetic member and having a magnetic flux oriented parallel and in alignment with the flux direction of the driving magnet in the engaged position.

11. The magnet motor according to claim 10 wherein the first fixed magnet and the driving magnet are spaced apart in the flux direction on opposing sides of first ferromagnetic member.

12. The magnet motor according to claim 1 wherein the first and second ferromagnetic members span one of the end faces of the driving magnet in the engaged position.

13. The magnet motor according to claim 1 wherein there is provided a first fixed magnet and a second fixed magnet, each fixed magnet comprising a permanent magnet supported in fixed relation to the first ferromagnetic member and having a magnetic flux oriented parallel and in alignment with the flux direction of the driving magnet in the engaged position, the first and second fixed magnets being supported spaced apart in the flux direction on opposing sides of the first ferromagnetic member.

14. The magnet motor according to claim 13 wherein the second fixed magnet is received between first ferromagnetic member and the driving magnet in the engaged position of the driving magnet.

15. The magnet motor according to claim 1 wherein the working direction is parallel to the end face of driving magnet which is nearest to the first ferromagnetic member.

16. The magnet motor according to claim 1 wherein the driving magnet is movable between the engaged and disengaged positions thereof in a plane which substantially parallel to working direction.

17. The magnet motor according to claim 1 wherein the driving magnet is movable between the engaged and disengaged positions thereof perpendicularly to the flux direction and perpendicularly to the working direction of the first and second ferromagnetic members.

18. The magnet motor according to claim 1 wherein the controller is arranged to linearly reciprocate the driving magnet between the engaged position and the disengaged position thereof.

19. The magnet motor according to claim 1 wherein the first and second ferromagnetic members are curved about a central axis, the working direction is oriented radially in relation to the central axis, and the driving magnet is movable in a tangential direction in relation to the central axis.

20. The magnet motor according to claim 19 wherein the controller is arranged to cyclically rotate the driving magnet between the engaged position and the disengaged position thereof.
